(19) United States
(12) Patent Application Publication
(10) Pub. No.: US 2002/0096969 A1
(43) Pub. Date: Jul. 25, 2002

(54) Calibration of voltage mode actuator driver with capacitive load

(76) Inventor: Terence Joseph Murphy, Plano, TX (US)

Correspondence Address: TEXAS INSTRUMENTS INCORPORATED, P O BOX 655474, M/S 3999, DALLAS, TX, 75265

(21) Appl. No.: 09/899,364

(22) Filed: Jul. 2, 2001

Related U.S. Application Data
(63) Continuation-in-part of application No. 09/681,695, filed on May 22, 2001.
(60) Provisional application No. 60/258,853, filed on Dec. 28, 2000.

(51) Int. Cl. H02N 2/00

(52) U.S. Cl. 310/314

(57) ABSTRACT

A piezo actuator drive circuit (100) adapted to be calibrated in a voltage mode. The present invention achieves technical advantages as a piezo actuator driver that can be calibrated in the voltage mode by switching a drive amplifier (42) output to a high impedance state and driving a load C_{piezo} with a fixed current source (I_{ref}) to characterize the load. Preferably, feedback resistors (R₁, R₂) configured as a resistive divide network are used as a sensor feeding and analog to digital converter.

### CLAIM OF PRIORITY

This application claims priority from U.S. provisional application Serial No. 60/258,853 entitled “Closed Loop Charge Mode Drive for Piezo Actuators Using DC Restore Amplifiers” filed Dec. 28, 2000.

### CROSS REFERENCE TO RELATED APPLICATIONS

This application is a continuation-in-part of commonly assigned U.S. patent application Ser. No. 09/681,695 entitled “Integrated Charge and Voltage Mode Drive Circuit for Piezo Actuators Used in Mass Data Storage Devices or the Like” filed May 22, 2001, the teachings of which are incorporated herein by reference:

### FIELD OF THE INVENTION

The present invention is generally related to the field of mass media information storage devices, and more particularly to a drive circuit and method for using a piezo actuator in a voltage mode.

### BACKGROUND OF THE INVENTION

Hard disk drives are mass storage devices that include a magnetic storage media, e.g. rotating disks or platters, a spindle motor, read/write heads, an actuator, a pre-amplifier, a read channel, a write channel, a servo circuit, and control circuitry to control the operation of hard disk drive and to properly interface the hard disk drive to a host system or bus. FIG. 1 shows an example of a prior art disk drive mass storage system 10. Disk drive system 10 interfaces with and exchanges data with a host 32 during read and write operations. Disk drive system 10 includes a number of rotating platters 12 mounted on a base 14. The platters 12 are used to store data that is represented as magnetic transitions on the magnetic platters, with each platter 12 coupleable to a head 16 which transfers data to and from a preamplifier 26. The preamp 26 is coupled to a synchronously sampled data (SSD) channel 28 comprising a read channel and a write channel, and a control circuit 30. SSD channel 28 and control circuit 30 are used to process data being read from and written to platters 12, and to control the various operations of disk drive mass storage system 10. Host 32 exchanges digital data with control circuit 30.

Data is stored and retrieved from each side of the magnetic platters 12 by heads 16 which comprise a read head 18 and a write head 20 at the tip thereof. The conventional readhead 18 and writehead 20 comprise magneto-resistive heads adapted to read or write data from/to platters 12 when current is passed through them. Heads 16 are coupled to preamplifier 26 that serves as an interface between read/write heads 18/20 of disk/head assembly 10 and SSD channel 28. The preamp 26 provides amplification to the waveform data signals as needed. A preamp 26 may comprise a single chip containing a reader amplifier 27, a writer amplifier, fault detection circuitry, and a serial port, for example. Alternatively, the preamp 26 may comprise separate components rather than residing on a single chip.

Piezo actuators have improved performance when driven by quantities of charge versus the amount of voltage applied to it. However, voltage mode drivers are traditionally simpler and cheaper to use. The charge mode drive improves two important areas of performance, both well documented in the literature, namely, effects over temperature, and effects due to hysteresis. To operate a piezo actuator in a charge mode configuration, the drive circuit output must be placed in a high impedance, open loop state. Disadvantageously, once in an high impedance state, the piezo actuator can drift through charge loss, wander due to transducer effects, or simply wander due to a variety of effects and lack of feedback.

There is desired an improved piezo actuator drive circuit that can be advantageously calibrated in a voltage mode configuration without the conventional drawbacks discussed above.

### SUMMARY OF THE INVENTION

The present invention achieves technical advantages as a piezo actuator driver that can be calibrated in the voltage mode by switching a drive amplifier output to a high impedance state and driving a piezo actuator with a fixed current to characterize the piezo actuator as a load. Preferably, feedback resistors configured as a resistive divide network are coupled to the piezo actuator in the calibration mode and are used as a sensor feeding an analog-to-digital converter (ADC).

The driver is selectively coupled to and disconnectable from an output stage current mirror that is a class AB amplifier. The output mirrors are disconnected from the Class AB stage during calibration, but are implemented in the voltage node. A fixed reference current is selectively coupled to the load by switching, whereby the resistor divide network is used to sense and characterize the piezo actuator as a load by sending a voltage that is indicative of the piezo actuator (i.e. postion) at the voltage divider output.

### BRIEF DESCRIPTION OF THE DRAWINGS

FIG. 1 illustrates a conventional disk drive system including multiple rotating disks or platters, read/write heads, a piezo actuator, a servo circuit, and associated amplifier and control circuitry;

FIG. 2 depicts a simplified schematic of the piezo drive circuit of the present invention including the DC restore feedback loop;

FIG. 3 is a graph of the AC response and DC response of the piezo actuator drive, the AC response being a function of the AC command signal and the DC response being a function of the DC offset;

FIG. 4 is a detailed schematic of the present invention;

FIG. 5 illustrates that portion of the schematic of FIG. 4 operative during the charge mode operation thereof;

FIG. 6 illustrates that portion of the schematic of FIG. 4 active during the voltage mode operation thereof;

FIG. 7 is a waveform diagram illustrating the transient response of the piezo actuator at both the output OUT1X and output OUT6XP;

FIG. 8 is a waveform depicting the transient response of the piezo actuator when driving 8 elements;

FIG. 9 is a graphical illustration of the outputs OUT1X and OUT6XP as a function of time for a power up sequence with the DC restore loop being initialized;

FIG. 10 is a schematic of another preferred embodiment providing calibration of a piezo driver in a voltage mode; and

FIG. 11 is a waveform timing diagram illustrating the output waveform and other signals during calibration as a function of the load and calibration resistors.

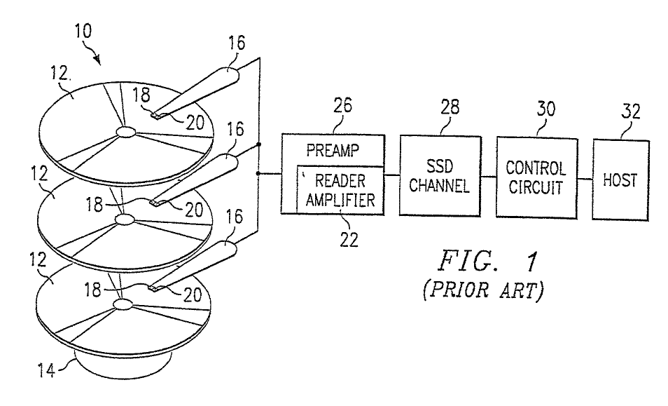

### DETAILED DESCRIPTION OF THE PREFERRED EMBODIMENT AND BEST MODE

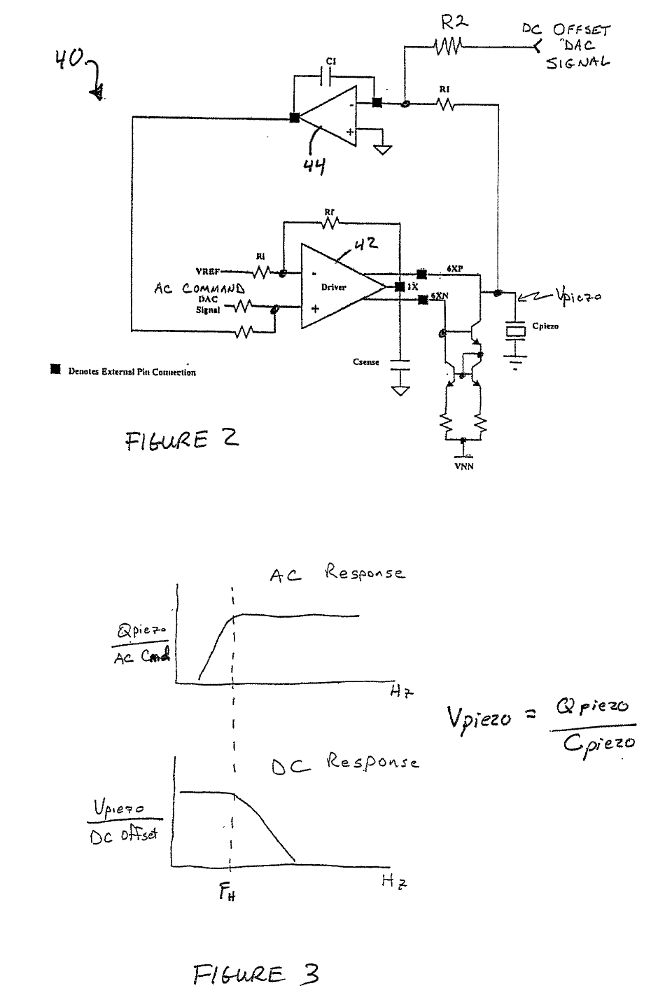

Referring now to FIG. 2, there is depicted at 40 a simplified schematic of the present invention seen to comprise a piezo actuator circuit adapted to drive a piezo actuator in both a charge mode and a voltage mode. Circuit 40 is seen to include a differential drive amplifier 42 having an inverting input connected to a voltage reference V_{ref}, and a non-inverting input coupled to and controlled by a AC command signal provided by a digital to analog converter (DAC) as will be discussed shortly. Driver 42 is seen to have a 1X output that is placed at a capacitor shown as C_{piezo}. Driver 42 also has two outputs identified as OUT6XP and OUT6XN coupled to current mirrors based on the currents of the OUT1X output. Each of these two outputs provides current equal to 6.125X the current sent out on the OUT1X output. This will be discussed in more detail shortly.

Circuit 40 is seen to further comprise of a low frequency voltage nulling loop around the charge control driver circuit 42 including an operational amplifier 44. The inverting input of amplifier 44 is coupled to the OUT6XP output, and having its output connected to the non-inverting input of driver 42, as shown. A feedback capacitor C1 is provided such that amplifier 44 is configured as a high frequency integrator. The feedback path from the OUT6XP output to the input of the driver 42 provided through the integrating DC restore amplifier 44 advantageously has the effect to null any DC offsets at the capacitor C_{piezo}. By providing this feedback, the system is overall balanced and the charge mode operation is maintained. The effect of the DC restore feedback removes any DC response from the DAC signal to the piezo output, however, this does not hinder system operation.

As mentioned above, the DC restore feature creates an AC coupled solution from the DAC input to the output OUT6XP, which is also referred to as the piezo drive node. It is also desired to have some control, from a DC coupled standpoint, as to where the OUT6XP output tends to at DC. Advantageously, this is accomplished with another input feature added through the offset DAC into a resistor, shown as the DC offset DAC signal coupled through resistor R2 and summed at the inverting input of amplifier 44. This resistor R2 is connected to the DC restore amplifier and allows for a low frequency DC coupled path and thus allows the DC positioning of the piezo in the charge mode to be changed.

Referring now to FIG. 3, there is depicted both the AC response and DC response of circuit 40. Notably, the AC response is flat above the bandpass frequency Fₕ, yet tapers to 0 below the bandpass frequency. Conversely, the DC response is flat below the bandpass frequency, but tapers off above the bandpass frequency at Fₕ. The AC response curve depicts on the vertical axis the value Q_{piezo}/AC command as a function of frequency. With respect to the DC response, the vertical axis depicts the relationship of V_{piezo}/DC offset as a function of frequency. The following relationship applies;

V_{piezo}=Q_{piezo}÷C_{piezo}

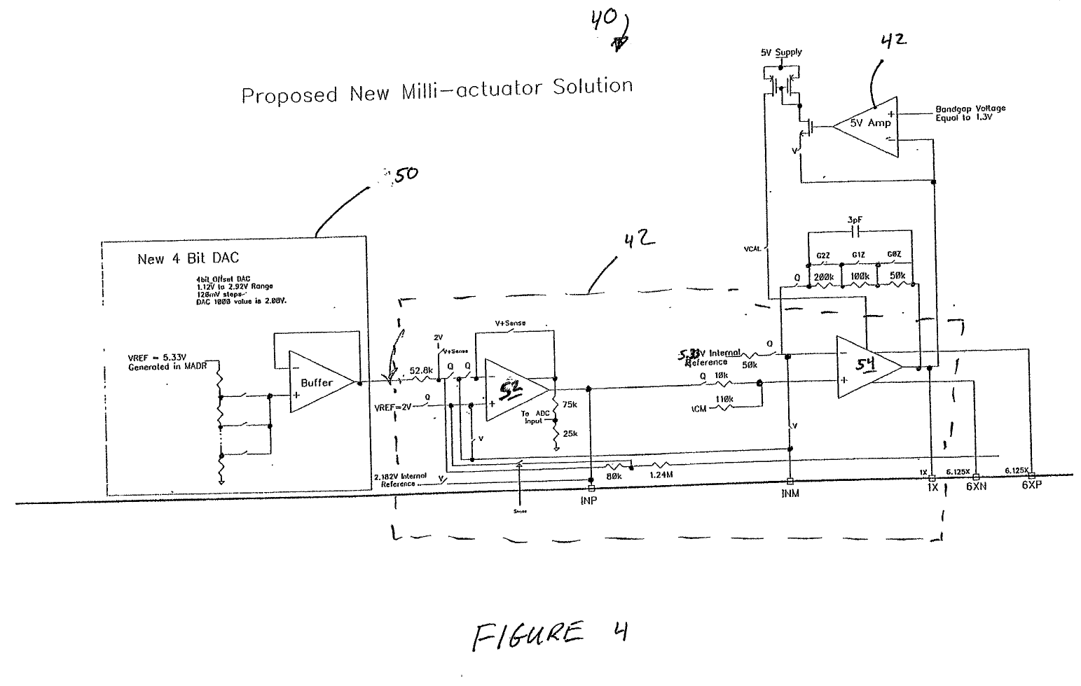

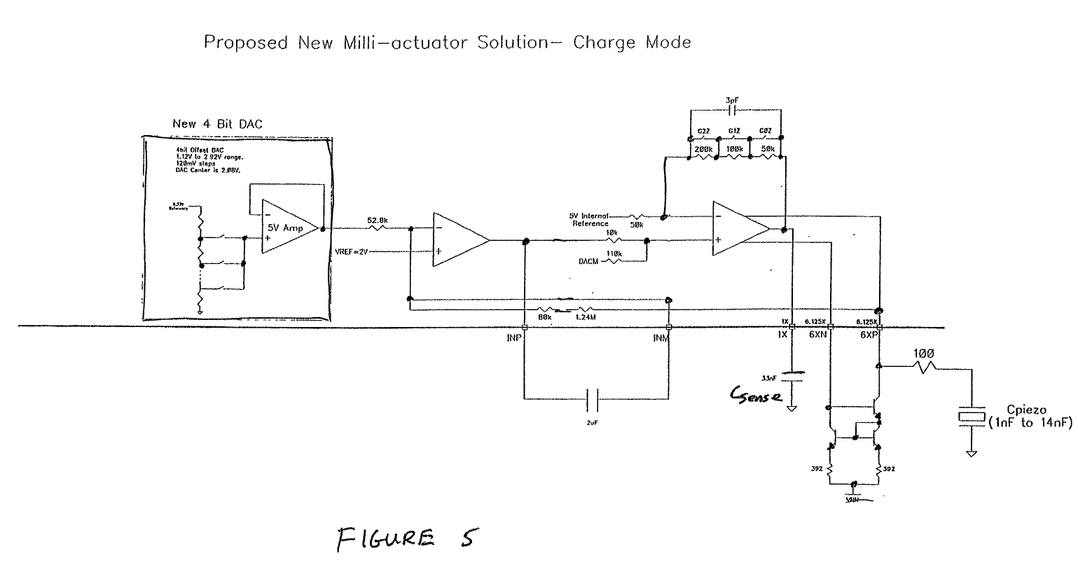

Turning now to FIG. 4, there is depicted a more detailed schematic of circuit 40, whereby the driver 42 is shown as amplifier 54 with feedback selectable by switches. The DC restore amplifier is depicted as amplifier 52 with its feedback and switches that select between charge and voltage mode. A four-bit digital-to-analog converter (DAC) 50 is seen to provide the DC command input to the inverting input as shown.

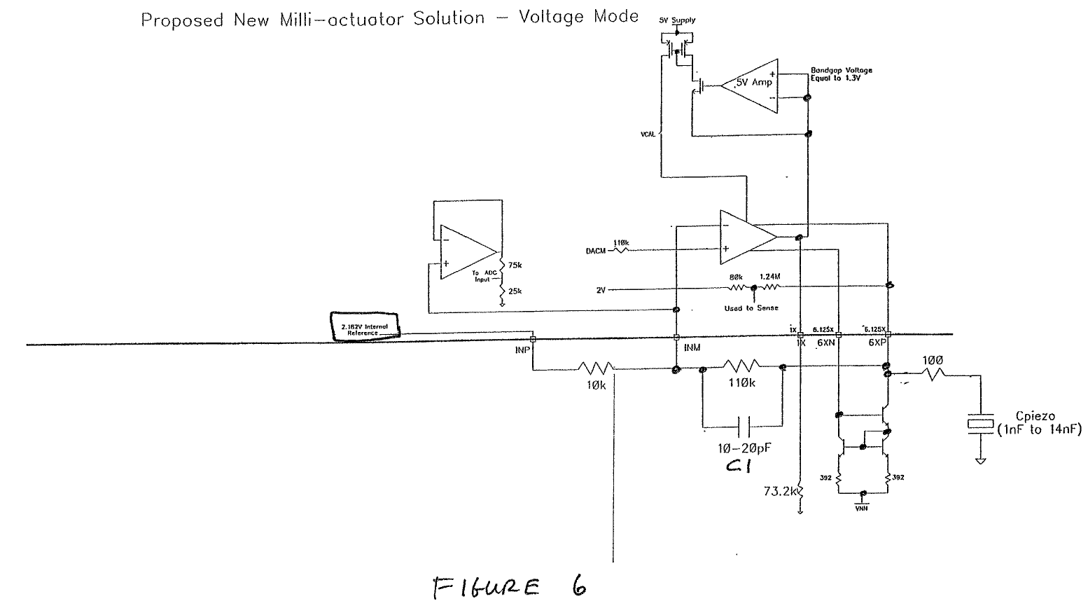

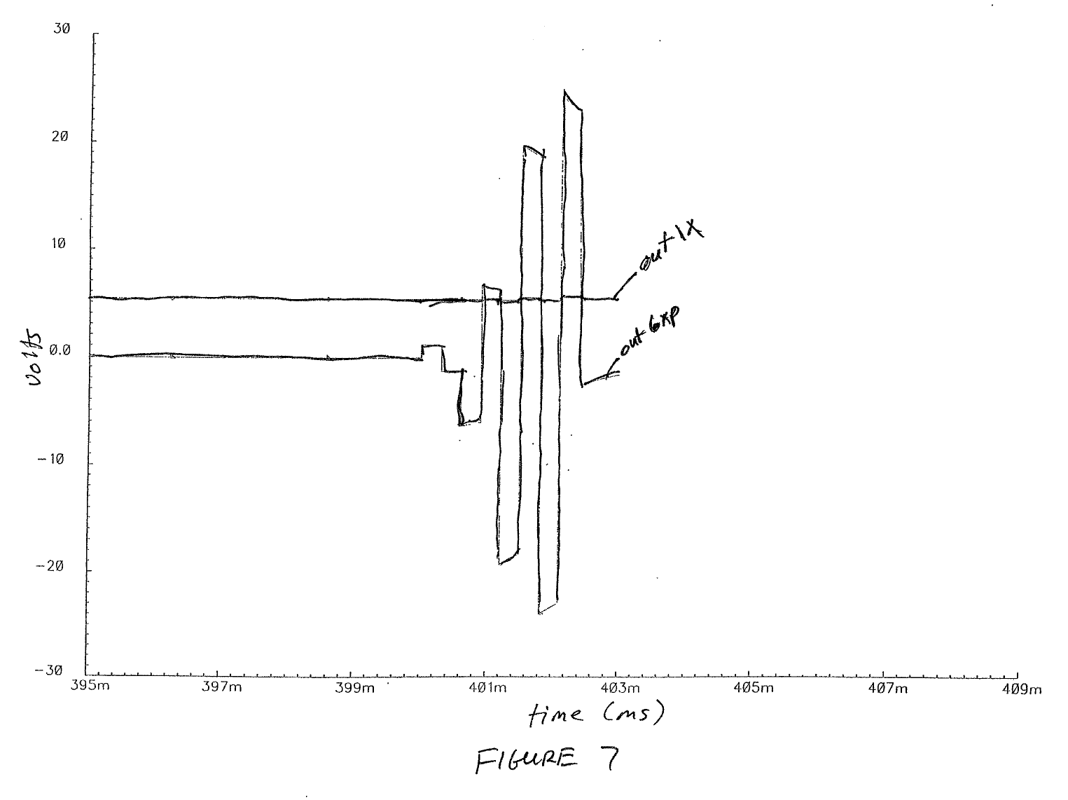

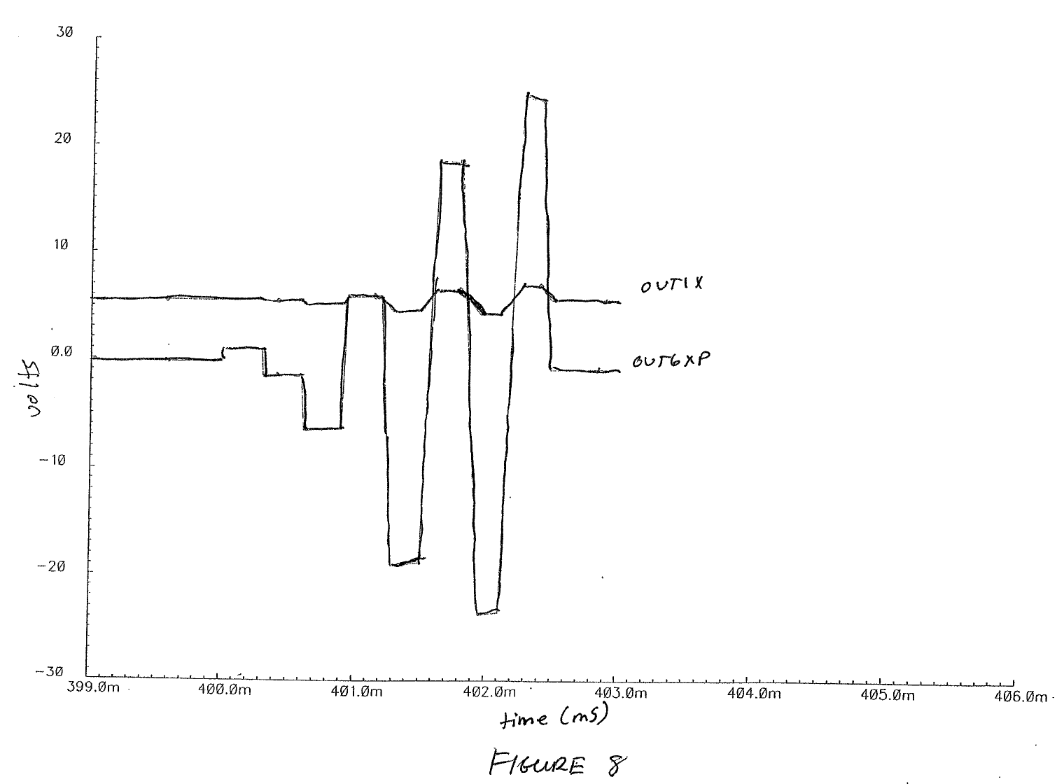

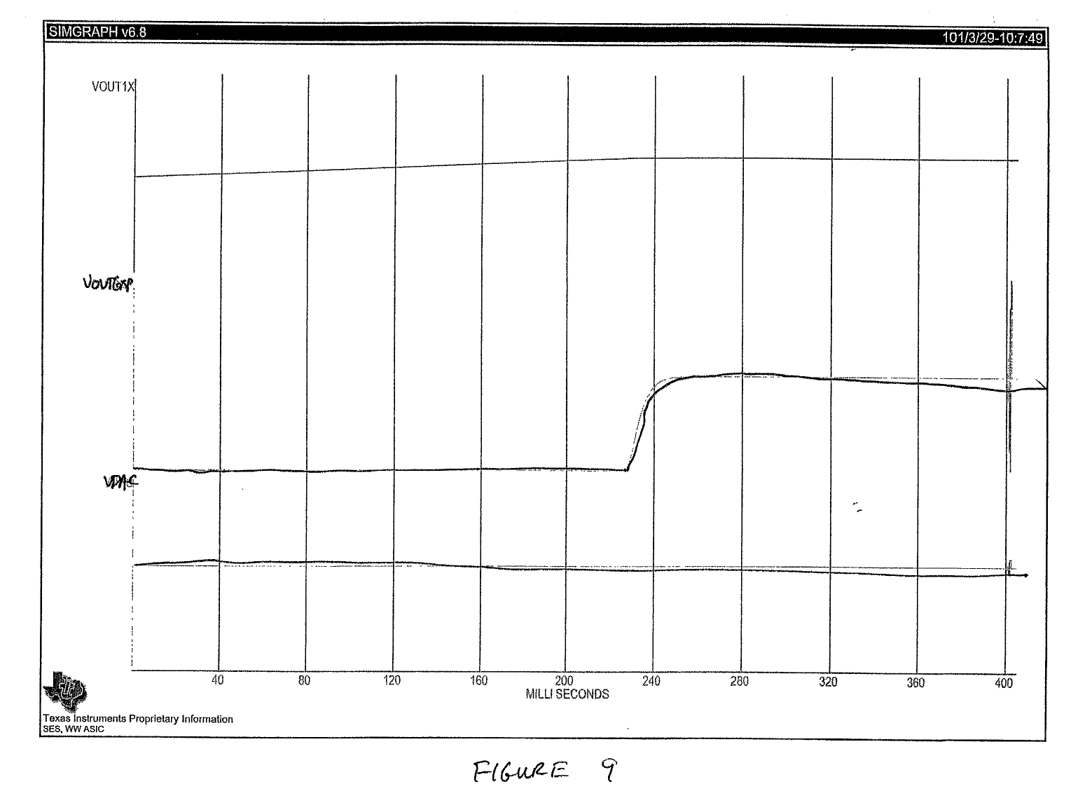

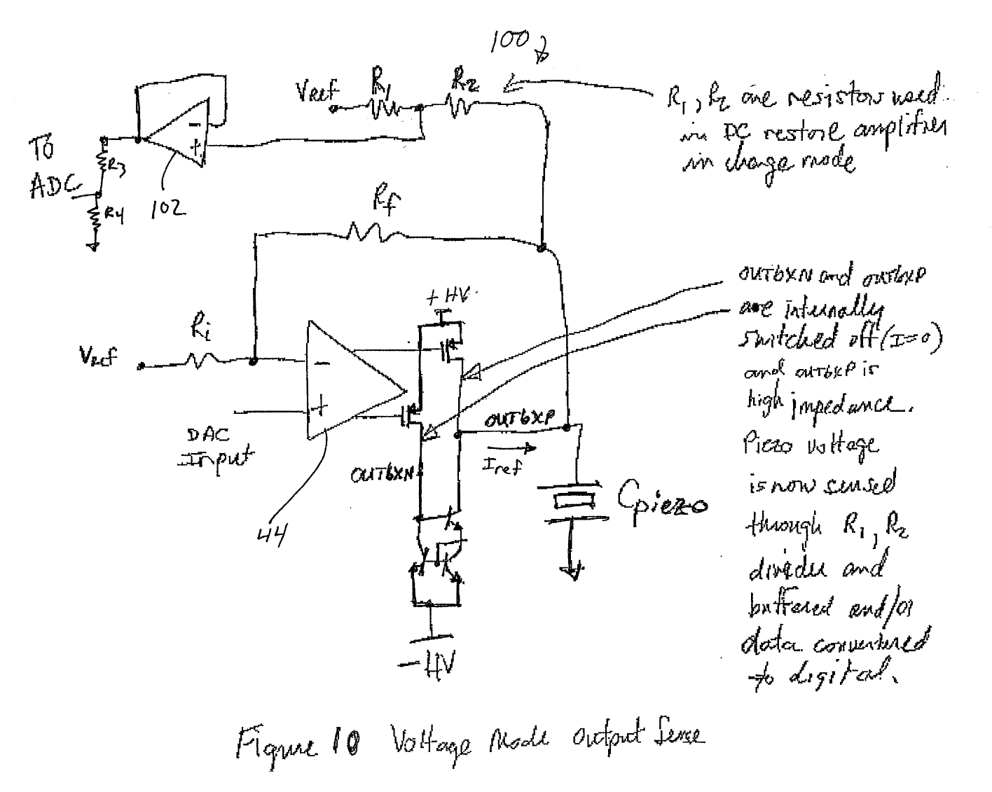

FIG. 5 depicts the active circuitry when the circuit is operating in the charge mode, and FIG. 6 illustrates the active circuitry of circuit 40 when the circuit operates in the voltage mode. Thus, reference to FIGS. 4,5 and 6 is made during the following discussion as to the operation of the present invention.

Circuit 40 provides the ability to program between voltage mode and charge mode operation by changing a MCTRL <3> bit in the serial port which controls a milliactuator signal QVZ. When in the voltage mode, the circuit operates with feedback capacitor C1 provided externally. The offset DAC is not active. The reference amplifier block provides a 2.182 volt bias voltage to the INP pin that is connected to the externally configured feedback. The voltage mode operation does have a calibration mode that is selected using a MCTRL <4> bit in the serial port which enables a milliactuator signal CAL. CAL mode provides a fixed positive current on the output OUT6XP which will charge the piezo capacitor C_{piezo}. The output voltage of the piezo is then sensed using the external resistor feedback network and the REFAMP2 amplifier of the drive block (_DRV). The REFAMP2 blocks output is sent to the ADC of the circuit and the customer has access to the desired piezo output voltage.

In the charge mode, the advantageous features of the milliactuator solution circuit 40 are featured. The features include the charge mode operation being provided for varying number of piezo elements, how the operation is maintained when normal offsets from processing are present, and how a DC coupled input is provided in conjunction with the DC restore operation.

The first advantageous feature is how the charge mode solution allows for a varying number of piezo elements. This is accomplished by setting up a voltage mode feedback on the OUT1X output using the amplifier 42. The feedback is internal to the integrated circuit (IC), but could be provided externally as well. The DAC input is at the input of the amplifier 42 and is gained up through the amplifier feedback and provided to the OUT1X output. A capacitor Cₛₑₙₛₑ is place on the OUT1X output. Based on the voltage swing of the capacitor and the capacitor value, a certain amount of charge is placed in the capacitor Cₛₑₙₛₑ. The OUT6PX and OUT6XN outputs are current mirrors based on the currents of the OUT1X output. These outputs each provide current equal to 6.125X the current sent out on the OUT1X signal. Given a certain amount of charge provided to the OUT1X output, 6.125 times this charge is provided to the OUT6XP or OUT6XN outputs depending on whether the charging on OUT1X is positive or negative −, that is, negative charging shows up on OUT6XN and vice versa for OUT6XP. If the load on OUT6XP, which is the main point of interest since the piezo element will be connected there, changes due to a different number of piezo elements used (this is common place for piezo actuator applications where a different number of actuators are being driven depending on the system configuration), then the output charge gain needs to be changed according to the number of piezo elements on the output.

Advantageously, this is accomplished by correspondingly switching the gain of the feedback on OUT1X and thus change the overall charge gain. One important aspect to this is that there are two important time constants that must be matched to keep the overall transfer function matched. The resistor value in the feedback on OUT1X multiplied by the capacitor used on OUT1X must match the output piezo capacitance (total load of all piezo elements used) and the resistance seen on the OUT6XP output. Therefore, the solution for changing the gain on the OUT1X is done with the overall feedback resistance changing using switches G0Z, G1Z and G2Z such that the RC product on the OUT1X is matched to the changing RC on OUT6XP, which changes with the number of piezo elements, and this is a key feature also provided by the solution.

The advantageous second feature is how the DC restore amplifier 44 is used to compensate for offsets in the OUT1X/OUT6XP circuit chain. There will be some current mismatch when the amplifier chain is manufactured, and this mismatch could cause the OUT6XP output to saturate into one rail or the other. This would make the solution non-usable and make the charge mode solution useless. To overcome this, a feedback path from the OUT6XP output to the input of the amplifier 42 is provided through the integrating DC restore amplifier 44. The effect of the feedback is to null any DC offsets. By providing this feedback, the system is overall balanced and the charge mode operation is maintained. The effect of the DC restore feedback does remove any DC response from the DAC signal to the piezo output, however, this does not hinder system operation.

The advantageous third feature is the DC coupled input. As mentioned above, the DC restore feature creates an AC coupled solution from DAC input to the OUT6XP output (piezo drive node). It is desired to also have some control, from a DC coupled standpoint, as to where the OUT6XP output tends to at DC. This is accomplished with another input feature added through the offset DAC into a resistor. This resistor R2 is connected to the DC restore amplifier and allows for a low frequency DC coupled path and thus allows the DC positioning of the piezo in charge mode to be changed.

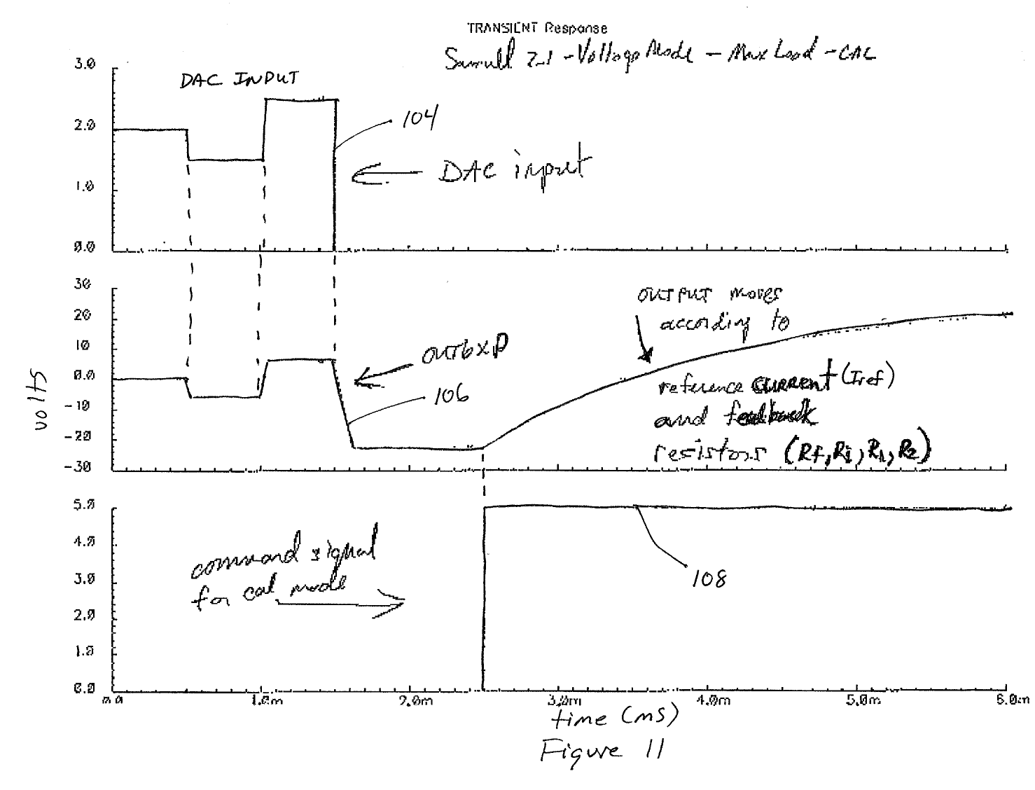

Referring now to FIG. 10, there is generally shown at 100 a piezo actuator drive circuit adapted to be calibrated in the voltage mode, wherein like numerals to those shown in earlier discussed Figures refer to like elements. The present invention achieves technical advantages by switching the output of the drive amplifier 42 to a high impedance state, disconnecting the output mirrors, and driving the piezo actuator with a fixed current source I_{ref}. The calibration can be switched to one or the other output mirror set. The fixed current I_{ref} sourced to the output load provides for a resulting output voltage to be sensed by a resistive divide network. The output sensed voltage is used to determine how much the piezo actuator load has varied, and can be used to compensate for previously mentioned unwanted defects. The driver output is sensed using the feedback of the amplifier itself and is measured using a resistor divider output which is coupled to an analog-to-digital converter (ADC).

Referring to FIG. 10, there is seen that a fixed predetermined calibration current I_{ref} is provided by output OUT6XP of amplifier 42 to the piezo actuator when calibrated in the voltage mode. In this mode, no current is provided by output OUT6XN, and the current mirror comprising a Class AB amplifier stage is operationally removed from the piezo actuator using switching FETs. This fixed reference current I_{ref} is generated outside this drive amplifier 42 To characterize the piezo actuator C_{piezo} in the calibration mode, the fixed current I_{ref} being sourced to the piezo actuator induces a voltage drop across the resistive divide network shown as resistors R₁ and R₂ forming a portion of the feedback in the voltage mode. The output of this resistive divide network, that is, the node between resistors R₁ and R₂, is provided to a sensing amplifier shown at 102 forming a buffer and subsequently feeding a resistive divide network shown as resistors R₃ and R₄. The output is sensed between resistors R₃ and R₄ and provided to the analog-to-digital converter (ADC). This sensed signal is indicative of the piezo actuator i.e. position and allows the circuit to characterize the changes of the load. These changes can then be compensated for, the previously mentioned undesirable parameters including temperature variation, voltage variation, and hysteresis effects. The present invention advantageously allows a voltage mode driver to be utilized which is simpler and cheaper to use while allowing the use of an existing amplifier design.

While the configuration is depicted for use with the output OUT6XP, it is understood that it is possible, and may be desirable in some instances, to also provide a reference current on output OUT6XN. In this instance, a negative reference current is provided to the output piezo actuator in a similar manner.

It is also noted that the feedback resistor network shown as resistor R_{f} and Rᵢ also form a resistive divider network, whereby a signal can be sensed between these resistors similar to that described with regards to the divider network formed of resistors R₁ and R₂. The advantage of using the resistors R₁ and R₂ is that they form a portion of the DC restore network and are coupled to a known voltage reference depicted as V_{ref} and which can also be used in the charge mode.

Referring to FIG. 11, there is depicted the DAC input signal at 104, the output OUT6XP signal at 106, and the command signal used in the calibration mode at 108. As shown, the output signal 106 moves according to the reference current I_{ref} and is a function of the feedback resistors R_{f}, Rᵢ, R₁ and R₂.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. A piezo actuator drive circuit, comprising:
a drive amplifier having an input, and an output adapted to drive a piezo actuator in a voltage mode; and
a calibration circuit coupled to the drive amplifier characterizing the piezo actuator in the voltage mode.

2. The drive circuit as specified in claim 1 wherein the calibration circuit is selectively coupled to the piezo actuator in a calibration mode.

3. The drive circuit as specified in claim 2 wherein the calibration circuit provides a predetermined current to the piezo actuator in the calibration mode.

4. The drive circuit as specified in claim 3 wherein the predetermined current is a fixed current.

5. The drive circuit as specified in claim 3 wherein the calibration circuit characterizes the piezo actuator as a function of the predetermined current.

6. The drive circuit as specified in claim 3 further comprising a sense circuit sensing a signal indicative of the piezo actuator when the predetermined current is provided thereto.

7. The drive circuit as specified in claim 6 wherein the sense circuit comprises a resistor divider providing a voltage signal.

8. The drive circuit as specified in claim 7 wherein the voltage signal varies proportionally to the piezo actuator load.

9. The drive circuit as specified in claim 6 wherein the drive amplifier has a feedback, wherein the sense circuit is a portion of the feedback.

10. The drive circuit as specified in claim 6 wherein the signal is indicative of the piezo actuator load variation.

11. The drive circuit as specified in claim 2 further comprising a current mirror selectively coupled to the output of the drive amplifier in the voltage mode.

12. The drive circuit as specified in claim 11 wherein the current mirror is selectively uncoupled from the drive amplifier in the calibration mode.

13 The drive circuit as specified in claim 12 wherein the current mirror is a class AB amplifier.

14. The drive circuit as specified in claim 1 wherein the drive amplifier has a voltage mode feedback configured to allow multiple piezo actuators to be driven in the charge mode.

15. The drive circuit as specified in claim 14 wherein the voltage mode feedback includes a capacitor coupled at the drive amplifier output, wherein the voltage mode feedback senses the voltage at the capacitor.

16. The drive circuit as specified in claim 15 wherein the voltage mode feedback has an adjustable gain being variable as a function of the number of piezo actuators driven.

17. The drive circuit as specified in claim 16 wherein the adjustable gain is accomplished using a variable resistor in the voltage mode feedback.

18. The drive circuit as specified in claim 1 wherein the drive amplifier has a first output, and a second output having a current mirror based on the first output.

19. The drive circuit as specified in claim 18 wherein a capacitor is coupled to the first output and the piezo actuators are adapted to be driven by the second output.

20. The drive circuit as specified in claim 19 wherein a first time constant formed by the capacitor and the voltage mode feedback, and a second time constant formed by the piezo actuators and the voltage mode feedback, are substantially equal.

21. The drive circuit as specified in claim 14 further comprising a DC control circuit controlling the DC value at the piezo actuator.

22. The drive circuit as specified in claim 21 wherein the DC control circuit is integrated into the low frequency compensation loop.

23. The drive circuit as specified in claim 1 further comprising a digital-to-analog (DAC) coupled to one drive amplifier input and a voltage reference being coupled to another drive amplifier input.

24. The drive circuit as specified in claim 1 further comprising an ADC coupled to the calibration circuit.
